(19) United States
(12) Patent Application Publication
(10) Pub. No.: US 2023/0174819 A1
(43) Pub. Date: Jun. 8, 2023

(54) RAPID HYDROPHOBIC SURFACE MODIFICATION COMPOSITIONS AND METHODS OF USE THEREOF

(71) Applicant: Energizer Auto, Inc., St. Louis, MO (US)

(72) Inventors: Chase Southwick Naisbitt, Columbia Station, OH (US); Grace Nabil Mahfouz, Rocky River, OH (US); Cindy Luna-Zaragoza, Tipp City, OH (US); Hirotaka Uchiyama, Loveland, OH (US)

(21) Appl. No.: 17/915,984

(22) PCT Filed: Apr. 20, 2021
(86) PCT No.: PCT/US2021/028107

§ 371 Date: Sep. 29, 2022

Related U.S. Application Data
(60) Provisional application No. 63/013,014, filed on Apr. 21, 2020.
(60) Provisional application No. 63/013,039, filed on Apr. 21, 2020.

(51) Int. Cl. C09D 183/08; C09D 183/10; C09D 7/20; C09D 5/02

(52) U.S. Cl. CPC C09D 183/08; C09D 5/022; C09D 7/20; C09D 183/10

(57) ABSTRACT

Described herein are compositions and methods for use in automotive care. In particular, the present disclosure is directed to compositions that provide an improved cure time and durability and methods of use thereof.

### CROSS-REFERENCE TO RELATED APPLICATIONS

This application claims priority to U.S. Provisional Application Serial No. 63/013039, filed on Apr. 21, 2020, and U.S. Provisional Application Serial No. 63/013014, filed on Apr. 21, 2020, the contents of which are hereby incorporated by reference in their entirety.

### FIELD OF THE DISCLOSURE

Described herein are compositions and methods for use in, for example, automotive care. In particular, the present disclosure is directed to compositions that provide an improved cure time and durability and methods of use thereof.

### BACKGROUND OF THE DISCLOSURE

Amino functionals impart hydrophobicity when applied surfaces of a car. Aqueous formulations including amino functional, however, contain high levels of surfactants and significantly slow the cure time before they can provide their full hydrophobic benefit. Additionally, if the product is in an aqueous solution, the chemistries necessary to create an emulsion significantly reduce the duration that the product will persist on the surfaces of the car.

Several of these issues have been addressed by using high levels of polar solvents with little to no water. This creates volatile organic compound (VOC) issues and contributes to a higher cost of the product. Other solutions include using high levels of nonionic surfactants, which reduces the overall performance of the amino functional siloxanes.

There remains a need, therefore, to address issues of slow cure time and compromised durability through the creation of a stable, cost-effective solution that when applied to an automotive surface performs better than previous methods.

### SUMMARY OF THE DISCLOSURE

In one aspect, the present disclosure is directed to a composition comprising: an amino functional silicone emulsion; and, an alcohol.

In another aspect, the present disclosure is directed to method of treating an automotive surface, the method comprising: applying a composition to an automotive surface, wherein the composition comprises: an amino functional silicone emulsion; and, an alcohol.

In yet another aspect, the present disclosure is directed to a composition comprising an amino functional silicone emulsion; an amino functional silicone; and, an alcohol.

In still another aspect, the present disclosure is directed to a method of treating an automotive surface, the method comprising: applying a composition to an automotive surface, wherein the composition comprises: an amino functional silicone emulsion; an amino functional silicone; and, an alcohol.

### DETAILED DESCRIPTION OF THE DISCLOSURE

Described herein are compositions and methods for use, for example, in the automotive care industry. In particular, the present disclosure addresses, among other things, the issues of slow cure time and compromised durability by creating a stable, cost-effective solution that when applied to an automotive surface performs better than previous methods.

In some embodiments, this is done by combining different combinations of an amino functional silicone emulsion, an amino functional silicone, and an alcohol. For example, in some embodiments, an amino functional silicone emulsion is combined with an amino functional silicone and ethanol. The emulsion and ethanol help to stabilize the free amino functional silicone. When the composition is applied to a car surface, the ethanol creates an azeotrope with water and starts to evaporate off the surface of the car. Once the ethanol starts to evaporate, the free amino functional silicone is destabilized and falls out of solution and rapidly migrates to the surface of the car where it starts to cure. This leads to simple product application with fast cure times without compromising durability.

In some embodiments, the composition comprises an amino functional silicone emulsion and an alcohol. In some embodiments, the composition comprises an amino functional silicone emulsion, an amino functional silicone, and an alcohol.

In some embodiments, the amino functional silicone emulsion comprises an aminoalkyl-functional organopolysiloxane fluid and water. In some embodiments, the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof. In some embodiments, the amino functional silicone emulsion is selected from the group consisting of Elkay LK Primasoft Power and Siltech E-4135.

In some embodiments, the amino functional silicone emulsion is soluble in water. In some embodiments, the amino functional silicone emulsion has a pH of from about 3 to about 7 or from about 3 to about 7.5.

In some embodiments, the amino functional silicone emulsion is present in an amount of from about 0.5% to about 25%, from about 3% to about 20%, from about 5% to about 15%, or about 12% by weight of the composition.

In some embodiments, the alcohol is selected from the group consisting of ethanol and isopropyl alcohol. In some embodiments, the alcohol is present in an amount of from about 0.1% to about 25%, from about 5% to about 20%, from about 10% to about 15%, or about 13% by weight of the composition.

In some embodiments, the amino functional silicone is an aminoalkyl-functional organopolysiloxane. In some embodiments, the amino functional silicone is Xiameter OFX-0536. In some embodiments, the amino functional silicone is present in an amount of from about 0.01% to about 2.0%, from about 0.1% to about 1.5%, from about 0.5% to about 1.3%, or about 1.0% by weight of the composition.

In some embodiments, the composition further comprises a preservative. In some embodiments, the preservative is present in an amount of from about 0.01% to about 2.0%, from about 0.05 to about 1.0%, or about 0.1 to about 0.5% by weight of the composition. In some embodiments, the preservative is Troyguard BC11.

In some embodiments, the composition further comprises a solvent. In some embodiments, the solvent is present in an amount of from about 60% to about 95% from about 65% to about 85%, from about 70% to about 80%, or about 75% by weight of the composition. In some embodiments, the solvent is water.

In some embodiments, the amino functional silicone emulsion is Siltech E-4135 and the alcohol is ethanol. In some embodiments, the amino functional silicone emulsion is Siltech E-4135 and the alcohol is isopropyl alcohol. In some embodiments, the amino functional silicone emulsion is Siltech E-4135, the alcohol is isopropyl alcohol, and the composition further comprises water and Troyguard BC11.

In some embodiments, the amino functional silicone emulsion is Siltech E-4135, the amino functional silicone is Xiameter OFX-0536, and the alcohol is ethanol. In some embodiments, the amino functional silicone emulsion is Siltech E-4135, the amino functional silicone is Xiameter OFX-0536, and the alcohol is isopropyl alcohol.

In an exemplary embodiment, the composition comprises the following formula:

| Ingredient | Wt.% in formulation | Purpose |
|---|---|---|
| Water | 74.90 | Solvent |
| Troyguard BC11 | 0.10 | Preservative |
| Isopropyl Alcohol | 13% | Evaporation aid |
| Siltech E-4135 | 12% | Amino Functional Silicone Emulsion |

The present disclosure is also directed to methods of treating an automotive surface or surfaces. In some embodiments, the automotive surface is selected from the group consisting of a tire, wheel, glass, paint, hood, roof, trunk, a plastic surface (e.g., vinyl), an exterior part, an interior part, and combinations thereof.

The compositions of the present disclosure provide an improved cure time. For example, a cure time of five minutes provides the full amino benefit whereas similar products recommend/need at least 24 hours. In some embodiments, the composition has a cure time of less than about 10 minutes, less than about 7 minutes, or less than about 5 minutes when applied to the automotive surface.

The compositions of the present disclosure also provide improved durability. For example, in some embodiments the composition lasts greater than 30 cycle washes whereas similar products are removed after the first wash. In some embodiments, the composition remains on the automotive surface after at least about 10 washes, about 20 washes, or about 30 washes.

In some embodiments, the composition is a fluid, such as a liquid, and the liquid is applied by the means of an aerosol, a trigger sprayer, a cloth, a paper, a nonwoven product (e.g., nonwoven cloth), a sponge, and combinations thereof.

The embodiments of this disclosure include:

1. A composition comprising:
an amino functional silicone emulsion; and,
an alcohol.

2. The composition of embodiment 1, wherein the amino functional silicone emulsion comprises an aminoalkyl-functional organopolysiloxane fluid and water.

3. The composition of embodiment 2, wherein the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof.

4. The composition of embodiment 1, wherein the amino functional silicone emulsion is selected from the group consisting of Elkay LK Primasoft Power and Siltech E-4135.

5. The composition of embodiment 1, wherein the amino functional silicone emulsion is soluble in water.

6. The composition of embodiment 1, wherein the amino functional silicone emulsion has a pH of from about 3 to about 7.

7. The composition of embodiment 1, wherein the amino functional silicone emulsion is present in an amount of from about 0.5% to about 25%, from about 3% to about 20%, from about 5% to about 15%, or about 12% by weight of the composition.

8. The composition of embodiment 1, wherein the alcohol is present in an amount of from about 0.1% to about 25%, from about 5% to about 20%, from about 10% to about 15%, or about 13% by weight of the composition.

9. The composition of embodiment 1, wherein the alcohol is selected from the group consisting of ethanol and isopropyl alcohol.

10. The composition of embodiment 1, further comprising a preservative.

11. The composition of embodiment 10, wherein the preservative is present in an amount of from about 0.01% to about 2.0%, from about 0.05 to about 1.0%, or about 0.1 to about 0.5% by weight of the composition.

12. The composition of embodiment 10, wherein the preservative is Troyguard BC11.

13. The composition of embodiment 1, further comprising a solvent.

14. The composition of embodiment 13, wherein the solvent is water.

15. The composition of embodiment 13, wherein the solvent is present in an amount of from about 60% to about 95% from about 65% to about 85%, from about 70% to 80%, or about 75% by weight of the composition.

16. The composition of embodiment 1, wherein the composition is applied to an automotive surface.

17. The composition of embodiment 16, wherein the automotive surface is selected from the group consisting of a tire, wheel, glass, paint, hood, roof, trunk, a plastic surface (e.g., vinyl), an exterior part, an interior part, and combinations thereof.

18. The composition of embodiment 16, wherein the composition has a cure time of less than about 10 minutes, less than about 7 minutes, or less than about 5 minutes when applied to the automotive surface.

19. The composition of embodiment 16, wherein the composition remains on the automotive surface after at least about 10 washes, 20 washes, or 30 washes.

20. The composition of embodiment 1, wherein the composition is a fluid, such as a liquid, and the liquid is applied by the means of an aerosol, a trigger sprayer, a cloth, a paper, a nonwoven product (e.g., nonwoven cloth), a sponge, and combinations thereof.

21. The composition of embodiment 1, wherein the amino functional silicone emulsion is Siltech E-4135, the alcohol is isopropyl alcohol, and the composition further comprises water and Troyguard BC11.

22. A method of treating an automotive surface, the method comprising:
applying a composition to an automotive surface, wherein the composition comprises:
an amino functional silicone emulsion; and,
an alcohol.

23. A composition comprising:
an amino functional silicone emulsion;
an amino functional silicone; and,
an alcohol.

24. The composition of embodiment 23, wherein the amino functional silicone emulsion comprises an aminoalkyl-functional organopolysiloxane fluid and water.

25. The composition of embodiment 24, wherein the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof.

26. The composition of embodiment 23, wherein the amino functional silicone emulsion is selected from the group consisting of Elkay LK Primasoft Power and Siltech E-4135.

27. The composition of embodiment 23, wherein the amino functional silicone emulsion is soluble in water.

28. The composition of embodiment 23, wherein the amino functional silicone emulsion has a pH of from about 3 to about 7.5.

29. The composition of embodiment 23, wherein the amino functional silicone emulsion is present in an amount of from about 0.5% to about 25%, from about 3% to about 20%, from about 5% to about 15%, or about 12% by weight of the composition.

30. The composition of embodiment 23, wherein the amino functional silicone is an aminoalkyl-functional organopolysiloxane.

31. The composition of embodiment 23, wherein the amino functional silicone is Xiameter OFX-0536.

32. The composition of embodiment 23, wherein the amino functional silicone is present in an amount of from about 0.01% to about 2.0%, from about 0.1% to about 1.5%, from about 0.5% to about 1.3%, or about 1.0% by weight of the composition.

33. The composition of embodiment 23, wherein the alcohol is present in an amount of from about 0.1% to about 25%, from about 5% to about 20%, from about 10% to about 15%, or about 13% by weight of the composition.

34. The composition of embodiment 23, wherein the alcohol is selected from the group consisting of ethanol and isopropyl alcohol.

35. The composition of embodiment 23, further comprising a preservative.

36. The composition of embodiment 35, wherein the preservative is present in an amount of from about 0.01% to about 2.0%, from about 0.05 to about 1.0%, or about 0.1 to about 0.5% by weight of the composition.

37. The composition of embodiment 35, wherein the preservative is Troyguard BC11.

38. The composition of embodiment 23, further comprising a solvent.

39. The composition of embodiment 38, wherein the solvent is water.

40. The composition of embodiment 38, wherein the solvent is present in an amount of from about 60% to about 95% from about 65% to about 85%, from about 70% to 80%, or about 75% by weight of the composition.

41. The composition of embodiment 23, wherein the composition is applied to an automotive surface.

42. The composition of embodiment 41, wherein the automotive surface is selected from the group consisting of a tire, wheel, glass, paint, hood, roof, trunk, a plastic surface (e.g., vinyl), an exterior part, an interior part, and combinations thereof.

43. The composition of embodiment 41, wherein the composition has a cure time of less than about 10 minutes, less than about 7 minutes, or less than about 5 minutes when applied to the automotive surface.

44. The composition of embodiment 41, wherein the composition remains on the automotive surface after at least about 10 washes, 20 washes, or 30 washes.

45. The composition of embodiment 23, wherein the amino functional silicone emulsion is Siltech E-4135, the amino functional silicone is Xiameter OFX-0536, and the alcohol is ethanol.

46. The composition of embodiment 23, wherein the amino functional silicone emulsion is Siltech E-4135, the amino functional silicone is Xiameter OFX-0536, and the alcohol is isopropyl alcohol.

47. The composition of embodiment 23, wherein the composition is a fluid, such as a liquid, and the liquid is applied by the means of an aerosol, a trigger sprayer, a cloth, a paper, a nonwoven product (e.g., nonwoven cloth), a sponge, and combinations thereof.

48. A method of treating an automotive surface, the method comprising:

applying a composition to an automotive surface,

wherein the composition comprises:
an amino functional silicone emulsion;
an amino functional silicone; and,
an alcohol.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A composition comprising:
an amino functional silicone emulsion; and,
an alcohol.

2. The composition of claim 1, wherein the amino functional silicone emulsion comprises an aminoalkyl-functional organopolysiloxane fluid and water.

3. The composition of claim 2, wherein the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof.

4. The composition of claim 1, wherein the amino functional silicone emulsion is present in an amount of from about 0.5% to about 25% by weight of the composition.

5. The composition of claim 1, wherein the alcohol is present in an amount of from about 0.1% to about 25% by weight of the composition.

6. The composition of claim 1, further comprising a preservative.

7. The composition of claim 1, further comprising a solvent.

8. A method of treating an automotive surface, the method comprising:
applying a composition to an automotive surface, wherein the composition comprises:
an amino functional silicone emulsion; and,
an alcohol.

9. The composition of claim 8, wherein the automotive surface is selected from the group consisting of a tire, wheel, glass, paint, hood, roof, trunk, a plastic surface, vinyl, an exterior part, an interior part, and combinations 5 thereof.

10. The composition of claim 8, wherein the composition is a fluid and the fluid is applied by the means of an aerosol, a trigger sprayer, a cloth, a paper, a nonwoven product, nonwoven cloth, a sponge, and combinations thereof.

11. A composition comprising:
an amino functional silicone emulsion;
an amino functional silicone; and,
an alcohol.

12. The composition of claim 11, wherein the amino functional silicone emulsion is present in an amount of from about 0.5% to about 25% by weight of the composition.

13. The composition of claim 11, wherein the amino functional silicone is an aminoalkyl-functional organopolysiloxane.

14. The composition of claim 11, wherein the amino functional silicone is present in an amount of from about 0.01% to about 2.0% by weight of the composition.

15. The composition of claim 11, wherein the alcohol is present in an amount of from about 0.1% to about 25% by weight of the composition.

16. The composition of claim 11, further comprising a preservative.

17. The composition of claim 11, further comprising a solvent.

18. A method of treating an automotive surface, the method comprising:
applying a composition to an automotive surface, wherein the composition comprises:
an amino functional silicone emulsion;
an amino functional silicone; and,
an alcohol.

19. The composition of claim 18, wherein the automotive surface is selected from the group consisting of a tire, wheel, glass, paint, hood, roof, trunk, a plastic surface, vinyl, an exterior part, an interior part, and combinations 5 thereof.

20. The composition of claim 18, wherein the composition is a fluid and the fluid is applied by the means of an aerosol, a trigger sprayer, a cloth, a paper, a nonwoven product, nonwoven cloth, a sponge, and combinations thereof.
